(19) United States
(12) Patent Application Publication
(10) Pub. No.: US 2012/0035942 A1
(43) Pub. Date: Feb. 9, 2012

(54) MANAGING BUSINESS RELATIONSHIPS USING A THIRD-PARTY SERVICE

(76) Inventors: Sven Graupner, Mountain View, CA (US); Julio Guijarro, Bristol (GB); Amitay Korn, Tefen (IL); Edward S. Reynolds, Plano, TX (US); Michael Kavanagh Smith, Austin, TX (US)

(21) Appl. No.: 12/852,208

(22) Filed: Aug. 6, 2010

(51) Int. Cl. G06Q 10/00

(52) U.S. Cl. 705/1.1

(57) ABSTRACT

A third-party service relationship may be established between a service consumer, a service provider, and a third-party service using a service relationship management server. The service consumer and service provider can have a primary service relationship. The primary service relationship may be managed using the service relationship management server. Service relationship information related to the primary service relationship can be received in a database in communication with the service relationship management server. The primary service relationship can be modified using the third-party service and based on the service relationship information.

### BACKGROUND

Many business applications and computational tasks have conventionally been performed upon a client or a server within a proprietary intranet. For example, a software application resident upon a client can be utilized by the client to effectuate operations such as creating data, obtaining data, manipulating data and/or storing data in memory associated with the client. Furthermore, business entities may employ one or more servers to perform tasks such as data storage/retrieval, data warehousing/analysis, electronic mail and/or backup services. These clients and servers within the intranet can include software applications that provide functionality such as network browsing, word processing, electronic mail management, and so forth. Some other services have been outsourced from the business to other service providers. Some example services in this category include provision of internet, telephone, payroll, and other services. The above-described operations, applications, and services, along with others not mentioned, may comprise business services.

Client and server hardware, software, and firmware resources can be expensive, as well as difficult and time consuming to install, update, troubleshoot and maintain. For example, upgrading server hardware can lead to lengthy downtimes during which email communications may be interrupted, employees may be unable to access data retained on the servers, and customers may be unable to view content or enter online commercial transaction. This can result in additional losses to a business in terms of lost profits, reduced employee productivity, etc. As a result, many businesses are turning to cloud services in which a third party which specializes in a particular application, service, etc., provides the desired business service to the business.

With the emergence of cloud services, the number and complexity of service relationships with various service providers can grow significantly for a business service consumer. Managing relationships with the service providers increasingly involves additional time, personnel, and thus costs to a service consumer.

### BRIEF DESCRIPTION OF THE DRAWINGS

FIG. 1 is a block diagram of a system for managing business relationships in accordance with an example of the present disclosure;

FIG. 2 is a block diagram of a service relationship management service system in accordance with another example;

FIG. 3 is a flow diagram of a method for managing business relationships using a third-party service in accordance with an example; and

FIG. 4 is a flow diagram of a method for managing business relationships using a third-party service in accordance with another example.

### DETAILED DESCRIPTION

Reference will now be made to the examples illustrated, and specific language will be used herein to describe the same. It will nevertheless be understood that no limitation of the scope of the technology is thereby intended. Additional features and advantages of the technology will be apparent from the detailed description which follows, taken in conjunction with the accompanying drawings, which together illustrate, by way of example, features of the technology.

The technology described herein comprises a third party service capable of supporting the management of relationships between service providers and service consumers. The third party service can be used to perform a variety of tasks, such as document management, contract management, contact management, reporting, billing, payment, and so forth. These tasks can be related to service relationships between service providers and service consumers and can be managed using the third party service according to the following description and examples.

The third party service described can provide centralized management of collateral documents which are produced and exchanged over the lifecycle of a service relationship. These collateral documents may be produced and exchanged by different organizations of people who are involved in establishing, maintaining and managing the business relationship (or at least one or more aspects of the business relationship) between the service provider and the service consumer. In addition to centralized document management, the third party service can provide automation tasks based on pre-defined templates of common and routine tasks. Examples of automation tasks include monthly reporting, accounting, payment for consumed services, and so forth.

More specifically, systems and methods for managing business relationships are described herein. In one example, a method is provided for managing business relationships using a third-party service. The method can include establishing a third-party service relationship between a service consumer, a service provider, and a third-party service using a service relationship management server. The service consumer and service provider can have a primary service relationship. The method can include managing the primary service relationship using the service relationship management server. Service relationship information related to the primary service relationship can be received in a database in communication with the service relationship management server. The primary service relationship can be modified using the third-party service and based on the service relationship information.

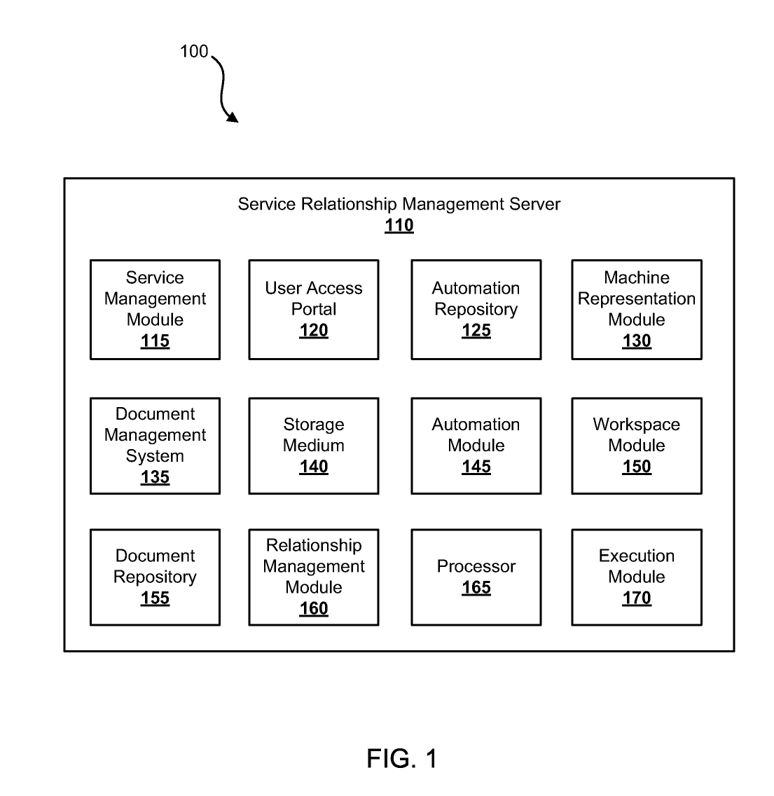

Referring to FIG. 1, a system 100 is shown for managing business relationships in accordance with an example of the present disclosure. It is noted that all of the individual components shown within the system are not required in every implementation, and no order or placement of a specific component is to be inferred. That being stated, the system includes a service relationship management server 110. The service relationship management server resides in a network, such as a local area network, wide area network, metropolitan area network, or any other suitable form of network, including intranet or internet networks. The network is accessible by a service provider and/or a service consumer to facilitate management of a primary service relationship between the service provider and the service consumer. For example, the service provider and/or service consumer may use a client computing device and access the service relationship management server through the network. In one example, the service relationship management server can be accessed by entering user credentials at an internet access portal, or a user access portal 120.

The service relationship management server 110 hosts a third-party service management module 115. The third-party service management module can enable management of the primary service relationship between the service consumer and the service provider. The third-party service management module can also be used to manage a third party service relationship between the third party service and the service provider or service consumer. Management of the third party service relationship is typically independent from the management of the primary service relationship. For example, a modification of the third party service relationship may not affect the primary relationship. Likewise, a modification of the primary relationship using the third party service management module may not affect the third party service relationship.

The system 100 can include a document management system 135. The document management system is configured to receive a document from at least one of the service consumer and the service provider and may comprise any form of document, such as a report, a bill, a contract, a statement, a database, etc. More broadly, the document may comprise any form of electronic file or transmission including, for example, at least one of text, audio, images, video, etc. In one aspect, the document comprises a contract, such as an end user license agreement (EULA), a service level agreement (SLA), etc. The contract can also include service terms.

For example, the contract may indicate under what conditions the service provider will provide a business service to the service consumer. As another example, the service terms can define guaranteed service availability. Thus, the contract may comprise any variety of service terms which can at least partially describe the relationship, rights, and/or responsibilities of the service provider, the service consumer, or both.

The system 100 can also include a document repository 155 or database for storing documents received by the document management system. The document repository comprises a non-transitory computer-readable storage medium 140 and can be in communication with the document management system 135. When a document is received by the document management system, the document is stored in the document repository. The document repository enables access to the document through the document management system upon demand by a user associated with the service consumer and/or service provider.

The system 100 can include a relationship management module 160. When present, the relationship management module is in communication with the third-party service management module 115 and is hosted on the service relationship management server 110. The relationship management module can also enable modification of the service terms by at least one of the service consumer and the service provider. In one example, the relationship management module can enable electronic communications between the service provider and the service consumer to facilitate modification of the service terms by the service provider and the service consumer. The electronic communications may be in the form of document exchange, electronic mail or messaging, instant messaging, voice over internet protocol telecommunications, etc. Modified service terms can be reflected in an updated document transmitted to the document management system 135. In another example, the service terms can be modified directly by the service consumer and/or service provider using the relationship management module and a processor 165. For example, service terms are stored in the form of data values on the service relationship management server and the data values can be modified using the relationship management module. As another example, the relationship management module enables renewal or cancellation of the primary service relationship and/or service terms.

The system 100 can also include an automation repository 125. The automation repository stores automation templates for automating service relationship maintenance operations. For example, a template provides for generating periodic reports, recurrently paying contractual fees, providing notification of service outages, making a one-time payment, changing a service configuration when predetermined conditions are satisfied, and so forth.

The automation repository 125 is typically accessed by a user through an automation module 145. The automation module enables a user to browse available automation templates and select a template for automating one or more service relationship management operations. The automation module further enables a user to select a desired automation template and/or configure the template. In one example, an automation template may comprise one or more user input fields where a user can configure periodicity of execution of the automation template, monetary amounts to be paid, notifications to be sent, service configurations to change, predetermined conditions for performing operations, contents of reports, recipients of reports and notifications, etc. In another example, an automation template may comprise variable fields populated according to service terms and/or other relationship details entered into the service management module and/or stored using the document management system. In another example, an automation template may comprise fixed fields which are not variable or user configurable and which define features of the automation template, such as periodicity of execution, etc.

The system 100 can further include an execution module 170 configured to execute a selected automation template. The execution module is configured to read the user input fields, variable fields, and/or the fixed fields and execute an automation template according to the various fields, and can include a scheduling module configured to schedule execution of automation templates which are to be executed at a time other than when the automation template is selected and configured. The execution module may also comprise a conflict checking module configured to analyze fields in a configured automation template to determine whether fields in the configured automation template conflict with service terms or other contractual agreements. The conflict checking module notifies one or both of the service provider and service consumer (or at least a responsible party associated with the service provider or service consumer) when a conflict is identified. The service provider and/or service consumer then determine whether to modify configuration of the automation template before execution. In a more detailed example, the execution module delays execution of an automation template until a user has either confirmed the execution or reconfigured the automation template.

In another aspect, the execution module 170 can be pre-configured to either perform specific operations when a conflict is identified by the conflict checking module rather than notifying a user and waiting for a response. For example, the execution module is configured to override any identified conflicts and execute the automation template. As another example, the execution module is configured to not execute an automation template when a conflict is present. The execution module also notifies a responsible party that an automation template will not be executed due to a conflict. As another example, the execution module can be configured to resolve (or attempt to resolve) identified conflicts.

The system 100 can include a machine representation module 130 which, in some examples, enables the above-described features, such as conflict checking, service terms being stored in the form of data values on the service relationship management server, etc. In one example, the machine representation module accepts user input from the service consumer or service provider to generate a machine representation of service terms, contractual terms, or various other forms of input. In another example, the machine representation module is configured to analyze documents stored in the document repository 155 and generate a machine representation of the contents of the document, such as by using optical character recognition (OCR), document analysis, and so forth. The machine representation of documents, terms, etc., provides a basis for management of the primary service relationship in terms of enabling modification of the primary service relationship, automatic population of fields in automation templates, and so forth. The machine representation module also makes the data values available to the service provider and/or service consumer for review, commenting, and modification through the relationship management module 160.

In one example, an automation template comprises variable fields which are populated according to data values obtained through the machine representation module 130. For example, the data values comprise contractual terms such as when payments for services are to be made and in what amount. The automation module 145 accesses the data values created by the machine representation module and stored in the document repository 155 and populates the variable fields in the automation template. The execution module 170 executes the automation template according to the contractual terms. Possibility of human error is also reduced because an operation is automated and will be performed even if a user forgets and also because a user is not inputting values into the automation template fields where values could be transcribed incorrectly.

The system 100 can also include a workspace module 150. The workspace module provides a separate workspace to a service consumer for multiple different service providers. The workspace module also provides a separate workspace to a service provider for multiple different service consumers. The workspace module also assists both service consumers and service providers in organizing various consumer-provider relationships and increase the efficiency of managing the relationships.

In one example, the workspace module 150 includes a sub-workspace module. The sub-workspace module divides a workspace into multiple sub-workspaces according to different individual aspects of the primary service relationship. For example, one sub-workspace may include a messaging center for electronic communications to be sent and received to and from the service provider and service consumer. Another example of a sub-workspace includes a monitoring center through which provision of the business service can be monitored. Another sub-workspace example includes a finance center through which management of financial terms, payments, etc. can be performed. Another sub-workspace example includes a relationship management center through which terms of the relationship can be provided, modified, terminated, renewed, etc. Various other workspaces and sub-workspaces may also be provided to suit a particular service and/or service relationship. Indeed, the workspaces and sub-workspaces can be virtually limitless in terms of purpose, functionality, configuration, number, etc.

The workspace module 150 and or sub-workspace module can be configured to provide selective access to the workspaces, sub-workspaces, and any other system component for management of primary service relationships. For example, a service consumer employs different users responsible for working with a particular service provider but not other service providers. Thus, the service consumer configures the workspace (or sub-workspace) module to restrict access to workspaces and sub-workspaces associated with the particular service or service provider. Additionally, the sub-workspaces can further be restricted such that individual users associated with the particular service or service provider are only allowed access to a particular aspect of the primary service relationship associated with that individual user. Thus, for example, technical aspects of the service relationship are restricted from individuals responsible for financial aspects. Likewise, communications, management, automation, and other aspects are also separately maintained.

A system comprising the features described herein can enable successful outsourcing relationship management between service providers and service consumers into an external third party service. The third party service can be used to fulfill a number of functions related to service consumer/provider relationships, such as document management, contact management, contract management, etc. The third party service can also be configured to act on behalf of the service consumer to automate routine tasks such as payment of monthly bills.

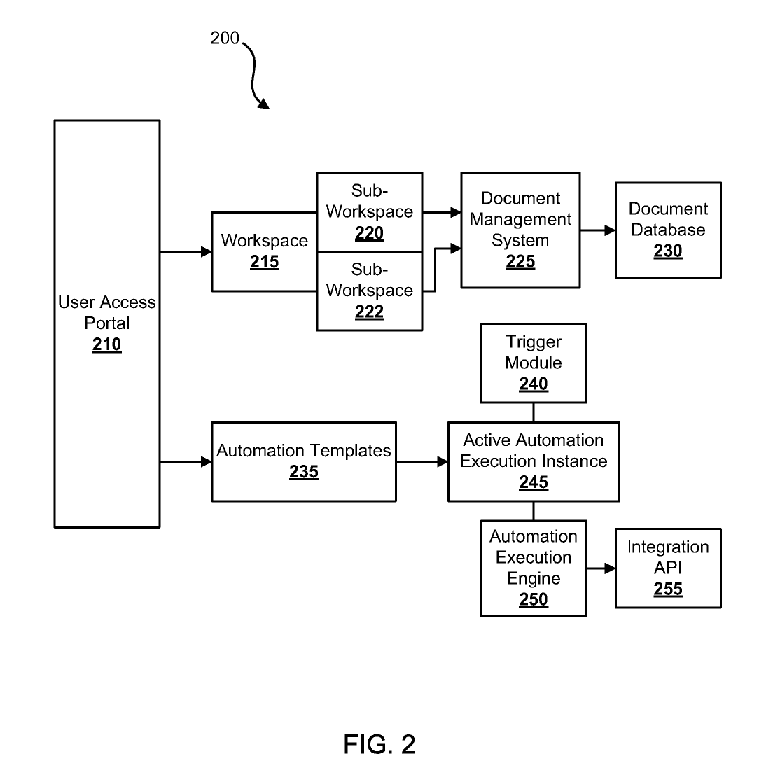

Referring to FIG. 2, a system 200 for a service-relationship management service is shown which can provide various functions including document management, contract management, contact management, and automation services, such as reporting, billing, payment. In addition to document management, the system can provide templates to enable users to select and customize common routine actions, which the service-relationship management service can then perform on behalf of the service consumer.

FIG. 2 illustrates various components of the system 200 for providing a service-relationship management service. In this example, a user access portal 210 (such as a web or internet based portal) is provided through which users can access the service. Users in different roles with different tasks and even from different organizations are allowed access to the system for management of one or more related or unrelated services. Based on the roles of the users, the users navigate through various business relationships currently being managed by the service.

Each business relationship between a service provider and a service consumer is represented by a workspace 215, which may be further sub-divided into sub-workspaces 220, 222 used for different aspects of the service relationship. Sub-workspaces may further be divided into sub-sub-workspaces as desired. Documents can be placed in a desired location within a hierarchy of workspaces. The workspaces are managed by a document management system 225 in the back-end of the third party service or service-relationship management service. The document management system also provides functionality for persistent storage of documents, management of versions of documents, persistent references for documents, and so forth. Electronic documents physically reside in a document database 230 in communication with the document management system.

In this example, the system 200 also includes a catalog of automation templates 235 with any number of predefined automation templates that enable the automation of routine or non-routine tasks occurring during a business relationship. A user selects a template, and can parameterize and customize the template via a dialog with the system. After configurable parameters have been set, an execution instance 245 is created and activated for the template. This active automation execution instance can exist in and be executed by an automation execution engine 250.

A trigger module 240 or a timer is used with the automation execution engine 250. When one or more predetermined criteria are met, or when a timer expires, the automation execution engine performs the execution of an automation instance. Execution of an automation instance often comprises performance of various computations and operations specified in the template by the execution engine. As a result of this execution, documents are created (e.g. a report) and stored in a specified workspace. Results of an execution can also be the output of data through an integration application programming interface (API) 255, which allows the service-relationship management service to be connected with other information technology (IT) systems. An example of such an integration API is the issuance of a payment order to a service consumer payment system to pay for a service rendered by a service provider.

Management of business relationships using a third-party service can also be accomplished using a variety of methodologies.

In one example, a method is provided for establishment, modification, and or termination of a service provider/consumer relationship. The method includes providing a service portal from which a user from a service consumer side logs into a third party service and creates a workspace in which the collateral (documents and the like) for the service relationship can be managed. The third party service automatically creates sub-spaces within the workspace according to configurable categories, such as sales/procurement, accounting, delivery, operations, incident management, etc. These categories can be used by users or teams of users associated with either the service provider or the service consumer in structuring service and service relationship materials, as well as isolating such materials which are maintained for other services or other categories of the same service. Created subspaces are typically assigned separate uniform resource locators (URLs) for quick reference and access.

In one example, the method includes provision of a form-based process driven by the third-party service, through which a user can enter various business information about the service provider or service consumer, including contacts, customer codes, business registrations and tax codes, etc. The user enters contacts from within the user's organization based on those contacts who are involved in establishing and managing aspects of the service provider/consumer relationship. The user also enters roles associated with the entered contacts to specify how a particular contact is involved in establishing and managing aspects of the service provider/consumer relationship. The third party service can contact the contacts based on the provided roles and offer appropriate sub-spaces to upload collateral related to the service provider/consumer relationship. Collateral related to the service provider/consumer relationship and uploaded by the contacts is managed and made available through the provided sub-spaces from which the collateral was received, and the collateral is managed using a document management system provided by the third party service.

The method can also include enabling users the ability to edit, change, replace, add, or delete collateral related to the service provider/consumer relationship as part of ongoing relationship management. The third party service also maintains version control over the managed collateral. At some point, a user may opt to terminate either the service relationship or the management of the service relationship by the third party service, both of which can be performed using the third party service. In one example, termination of either the service relationship or the management of the service relationship causes the third party service to archive all remaining collateral. In another example, termination of either the service relationship or the management of the service relationship causes the third party service to delete all remaining collateral.

A method for management of collateral related to a service provider/consumer relationship is also provided. The method includes enabling a user to upload collateral (such as documents, spreadsheets, etc.) into a sub-workspace at the creation of a workspace or sub-workspace. The third party service can manage the uploaded collateral documents using a document management system while providing access and visibility, control, backup, archival, versioning and other document management capabilities. Each collateral document managed by the document management system is typically assigned a unique and permanent URL by which the document can be accessed or referenced, and the URL references distributed and shared. In one aspect, the URL references are accessible by anyone providing the appropriate credentials. In another aspect, the URL references can be accessed by anyone having possession of the URL.

In another example, a method is provided for selection and customization of an automation template. In addition to document management capabilities, the third party service relationship management service can enable automation of certain activities. For example, activities which are common in relationship management may be the subject of an automation template. In another example, the system enables a user to create and define an automation template. Activities defined in the form of templates can be selected and customized by a user. A user selects an automation template from the relationship management service through a user portal. The service typically offers a variety of templates, such as templates for recurring billing, recurring payment, recurring report generation, etc.

After the user has selected a template, an execution instance of this template is created and assigned to a specific service relationship under management by the third party service. The execution instance drives a dialog with the user, during which the automation task can be further specified and customized. For example, payment and account information is provided during this dialog. Other specifications include that of a trigger for activating an automated execution (e.g., on explicit request, scheduled, periodicity, one-time execution vs. recurring execution, etc.). When specifications of an automation task or automation template have been completed, the execution instance is then activated.

A method is also provided for execution of a customized automation template in accordance with an example of the present disclosure. After a template execution instance has been activated as described above, internal logic within the template execution instance can begin functioning. For example, the template execution instance begins waiting for a specified triggering event to occur. The method includes triggering the trigger with an event, and the trigger can cause the beginning of automation activity execution. In one example, the event can be reaching of a predetermined time, expiration of a timer, receipt of a user request, etc. The trigger causes the execution instance to execute built-in logic on which an associated automation template was formed. During the execution, various inputs connected to the automation task are processed and an output is produced. The various inputs and/or outputs in turn trigger additional automation tasks or produce a result which is transmitted to a predefined location (e.g., a report). After the execution has terminated, the execution instance may be destroyed if it is a one-time execution instance, or may remain active waiting for further triggers to occur.

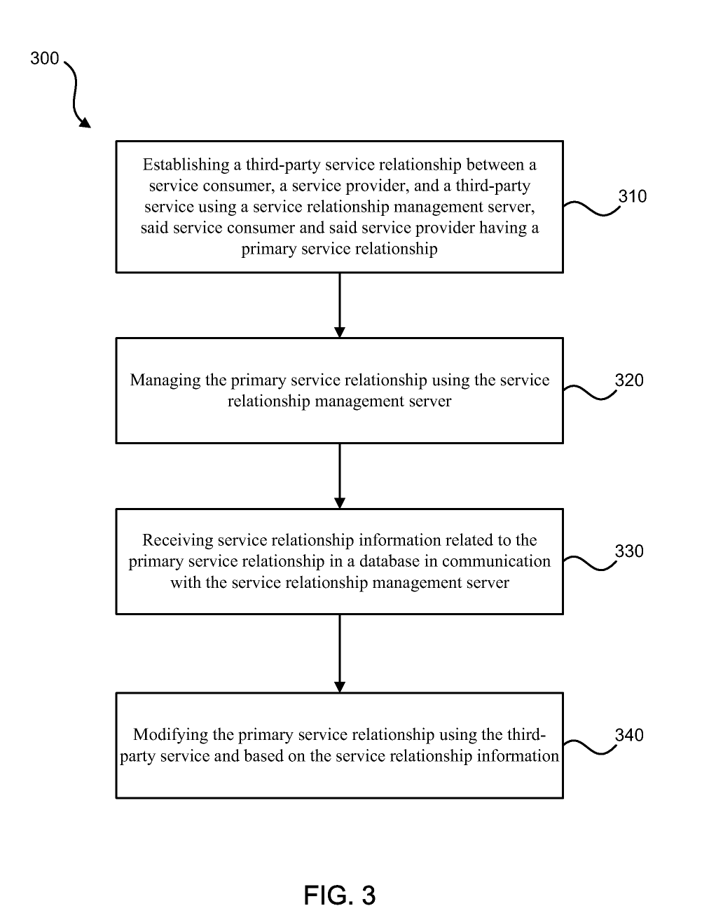

Referring to FIG. 3, a flow diagram of a method 300 for managing business relationships using a third-party service is illustrated in accordance with an example of the present disclosure. The method includes establishing 310 a third-party service relationship between a service consumer, a service provider, and a third-party service using a service relationship management server. The service consumer and the service provider can have a primary service relationship while the relationship between the service consumer/provider and the third party service can be the third party service relationship. The primary service relationship can be created using the third party service or may exist prior to the establishment of the third party service relationship. The method also includes managing 320 the primary service relationship using the service relationship management server. Service relationship information related to the primary service relationship is received 330 in a database in communication with the service relationship management server. The service relationship information may comprise any suitable form of electronic information, including documents and so forth as described above. The method also includes modifying 340 the primary service relationship using the third-party service and based on the service relationship information.

In more specific implementations of the method, the service relationship information may comprise a service contract. Also, modification of the service relationship may comprise at least one of changing or ending the primary service relationship.

In one example, the method includes monitoring a service provided by the service provider to determine whether provision of the service is in compliance with a service agreement. For example, the third party service may provide a monitoring module for monitoring the provision of the service for the service provider or service consumer. In one aspect, the monitoring module comprises a user input module on a service relationship management server and is configured to receive input from the service provider or service consumer regarding the provision of the service. For example, the input comprises confirmation that the service is being provided, that the service is not being provided, or that the service is not being provided according to agreed-upon terms. In another aspect, the monitoring module comprises a software module for download onto a service consumer (or provider) client. The monitoring module can be configured to periodically test whether the service is being provided and to provide a periodic report based on results of the test. For example, if the service is provision of an e-mail exchange server, the monitoring module can be configured to ping the exchange server at predetermined intervals to determine availability of the server during a reporting period and can report on the availability of the server at the end of the reporting period. The report is thus transmitted to the service provider, the service consumer or both. Alternatively, the report is transmitted to the service relationship management server and the report is compared with contract terms rendered by the machine representation module to determine whether the service is in contractual compliance. Billing, payment, service renewal, etc. can then be automatically managed and/or modified by or using the service relationship management server based on the contractual compliance.

In other implementations of the method, the method includes performing service relationship maintenance operations through the third-party service based on the machine representation of a service contract stored on the service relationship management server. The method can include providing a plurality of automation templates to the service consumer for automation of service relationship maintenance operations. In one example, consumer-configurable portions of the automation templates can be limited according to the machine representation of the service contract stored on the service relationship management server. In other words, for example, if the service contract specifies that payment is to be made between the 1^{st} and the 15^{th} day of each month, an automation template restricts user-configurable payment dates to dates between the 1^{st} and the 15^{th}. The method can further include executing an automation template according to the contract terms within the machine representation of the service contract.

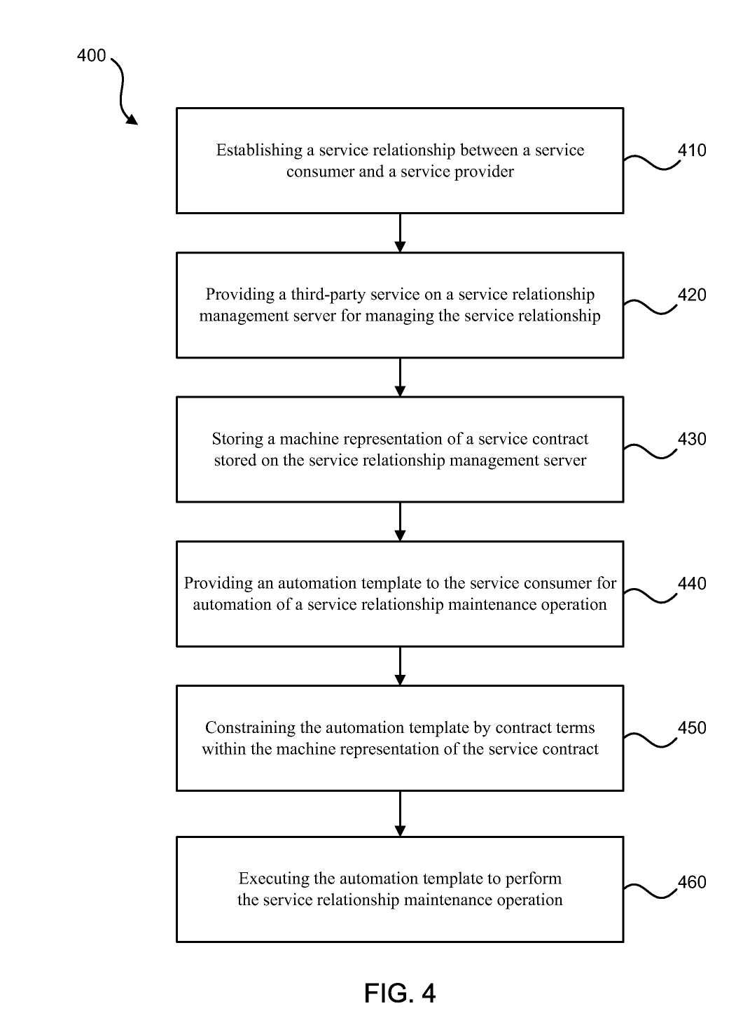

Referring to FIG. 4, a flow diagram of another method 400 for managing business relationships using a third-party service is illustrated in accordance with an example of the present disclosure. This method includes establishing 410 a service relationship between a service consumer and a service provider. A third-party service is provided 420 on a service relationship management server for managing the service relationship. A machine representation of a service contract stored on the service relationship management server is stored 430 in a document repository. An automation template is provided 440 to the service consumer for automation of a service relationship maintenance operation and the automation template is constrained 450 by contract terms within the machine representation of the service contract. The method also includes executing 460 the automation template to perform the service relationship maintenance operation. In one example, the service relationship maintenance operation may include at least one of renewing, reporting, or renegotiating the service relationship, or the payment of bills. In the case of bill payment, the method can include making payments in amounts and in intervals as defined by the contract terms.

The systems, methods, and service-relationship management services described herein enable the combination of various tasks and activities related to the management of service provider/consumer relationships in one central place which may be accessible to all individuals, teams and parties involved in the management of the service provider/consumer relationship. Centralizing and organizing collateral produced by individuals, groups of individuals, entities, and so forth while managing the various stages of a service provider/consumer relationship may increase the visibility of the relationship and enhance conversations and use of collateral between users in the context of the same provider/consumer relationship. The systems, methods, and services also provide a container for storage of collateral documents produced and exchanged in the context of a provider/consumer relationship. Since the third party service is an external service to both the service provider and the service consumer access to the collateral can be managed independently of corporate administrative boundaries.

The methods and systems of certain examples may be implemented in hardware, software, firmware, or combinations thereof. The methods disclosed herein can be implemented as software or firmware that is stored in a memory and that is executed by a suitable instruction execution system (e.g., a processor). If implemented in hardware, the methods disclosed herein can be implemented with any suitable technology that is well known in the art.

Also within the scope of this disclosure is the implementation of a program or code that can be stored in a non-transitory machine-readable medium to permit a computer or processor to perform any of the methods described above.

Some of the functional units described in this specification have been labeled as modules, in order to more particularly emphasize their implementation independence. The various modules, engines, tools, etc., discussed herein may be, for example, software, firmware, commands, data files, programs, code, instructions, or the like, and may also include suitable mechanisms. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

While the forgoing examples are illustrative of the principles of the present technology in one or more particular applications, it will be apparent to those of ordinary skill in the art that numerous modifications in form, usage and details of implementation can be made without departing from the principles and concepts of the technology. Accordingly, it is not intended that the technology be limited, except as by the claims set forth below.

What is claimed is:

1. A method for managing business relationships using a third-party service, comprising:
establishing a third-party service relationship between a service consumer, a service provider, and a third-party service using a service relationship management server, said service consumer and said service provider having a primary service relationship;
managing the primary service relationship using the service relationship management server;
receiving service relationship information related to the primary service relationship in a database in communication with the service relationship management server; and
modifying the primary service relationship using the third-party service and based on the service relationship information.

2. A method for managing business relationships as in claim 1, wherein the service relationship information comprises a service contract.

3. A method for managing business relationships as in claim 1, wherein modifying the service relationship comprises at least one of changing or ending the primary service relationship.

4. A method for managing business relationships as in claim 1, further comprising monitoring a service provided by the service provider to determine whether provision of the service is in compliance with a service agreement.

5. A method for managing business relationships as in claim 1, further comprising performing service relationship maintenance operations through the third-party service based on a machine representation of a service contract stored on the service relationship management server.

6. A method for managing business relationships as in claim 1, further comprising providing a plurality of automation templates to the service consumer for automation of service relationship maintenance operations.

7. A method for managing business relationships as in claim 6, wherein consumer-configurable portions of the automation templates are limited according to a machine representation of a service contract stored on the service relationship management server.

8. A method for managing business relationships using a third-party service, comprising:
providing a third-party service on a service relationship management server for managing a service relationship between a service consumer and a service provider;
storing a machine representation of a service contract stored on the service relationship management server;
providing an automation template to the service consumer for automation of a service relationship maintenance operation;
constraining the automation template by contract terms within the machine representation of the service contract; and
executing the automation template to perform the service relationship maintenance operation.

9. A method for managing business relationships as in claim 8, wherein the service relationship maintenance operation comprises at least one of renewing, reporting, or renegotiating the service relationship.

10. A method for managing business relationships as in claim 8, wherein the service relationship maintenance operation comprises payment of bills in amounts and in intervals defined by the contract terms.

11. A method for managing business relationships as in claim 8, further comprising receiving a user selection of the automation template from a plurality of automation templates.

12. A system for managing business relationships, comprising:
a service relationship management server;
a third-party service management module hosted on the service relationship management server, the third-party service management module being configured to enable management of a service relationship between a service consumer and a service provider;
a user access portal on the service relationship management server for enabling access to the third-party service management module by at least one of the service consumer and the service provider;
a document management system configured to receive a document from at least one of the service consumer and the service provider, wherein the document comprises service terms;
a non-transitory computer-readable storage medium for storing the document; and
a relationship management module in communication with the third-party service management module and hosted on the service relationship management server, the relationship management module being operable to enable modification of the service terms by at least one of the service consumer and the service provider.

13. A system as in claim 12, further comprising:
an automation repository configured to store automation templates for automating service relationship maintenance operations;
an automation module configured to receive user selection of at least one automation template from the automation repository; and
an execution module configured to execute the at least one automation template.

14. A system as in claim 13, further comprising a machine representation module configured to provide a machine representation of the document, and wherein the execution module is configured to execute the at least one automation template according to the service terms in the machine representation of the document.

15. A system as in claim 12, further comprising a workspace module operable to provide a separate workspace for a plurality of different service providers, the workspace module further comprising a sub-workspace module operable to divide the separate workspaces into a plurality of sub-workspaces according to different individual aspects of the service relationship and to provide access to different users associated with the service consumer based on an individual aspect of the service relationship associated with an individual user.
